(19) United States
(12) Patent Application Publication
(10) Pub. No.: US 2019/0249653 A1
(43) Pub. Date: Aug. 15, 2019

(54) COMPRESSOR

(71) Applicant: FUJITSU GENERAL LIMITED, Kanagawa (JP)

(72) Inventor: Takashi SUZUKI, Kanagawa (JP)

(73) Assignee: FUJITSU GENERAL LIMITED, Kanagawa (JP)

(21) Appl. No.: 16/343,841

(22) PCT Filed: Nov. 29, 2017
(86) PCT No.: PCT/JP2017/042807

§ 371 Date: Apr. 22, 2019

(30) Foreign Application Priority Data
Nov. 30, 2016 (JP) 2016-232244

(51) Int. Cl. F04B 35/04; F04B 27/00; H02K 1/16; H02K 1/18; H02K 3/34

(52) U.S. Cl. CPC F04B 35/04; F04B 27/005; F25B 1/02; H02K 1/18; H02K 3/34; H02K 1/16

(57) ABSTRACT

There is provided a technology for properly preventing an insulation member from melting during welding without reducing the efficiency of a motor. A compressor includes: a motor including a shaft, a rotor fixed to the shaft, and a stator surrounding the rotor; a compression unit that compresses a refrigerant as a result of rotation of the shaft; and a shell that houses the shaft, the motor, and the compression unit therein. The stator includes a stator core including an annular back yoke portion, a plurality of teeth portions, and slots formed between adjacent teeth portions, coils wound around the plurality of teeth portions, an insulation member that is disposed in the slots and interposed between the stator core and the coils to insulate the stator core and the coils, and at least one projection portion that forms a gap.

### TECHNICAL FIELD

The present invention relates to a compressor in which a motor as a driving source that drives a compression unit is fixed to a shell by welding.

### BACKGROUND ART

From the past, a compressor used for air conditioners, refrigerators, and the like is widely known. In general, this type of compressor includes a compression unit, a motor that drives a compression unit, and a shell that forms an enclosed space while housing the compression unit and the motor therein.

As the motor, a radial gap motor is generally used. The stator of the motor includes a stator core including a back yoke portion and teeth portions, and coils wound around the teeth portions. In the stator, slots are formed between adjacent teeth portions. In the slots, an insulation film as an insulation member, which insulates the stator core and the coils is provided.

In this type of compressor, there is a need to fix the motor in the shell. In this case, the back yoke portion of the stator core is fixed to the shell by spot welding or the like. However, there is a problem that at this time, the heat during welding is transmitted to the insulation film via the back yoke portion, which causes the insulation film to melt.

As a technology for solving such a problem, the following Patent Literature 1 is disclosed. In the technology described in the cited literature 1, a gap is formed between the back yoke portion and the insulation film (slot cell) by providing a recess in a part of the back yoke portion facing the slots, which prevents the slot cell from melting by the heat during welding.

### CITATION LIST

### Patent Literature

Patent Literature 1: Japanese Patent No. 4670984

### DISCLOSURE OF INVENTION

### Technical Problem

However, if a recess is formed in the back yoke portion as in the technology described in Patent Literature 1, there is a problem that the magnetic path becomes narrow and long and the magnetic resistance becomes large, which reduced the efficiency of the motor. In particular, in the technology described in Patent Literature 1, the magnetic path is narrowed in the part of the back yoke portion facing the slots, i.e., the part with a high magnetic flux density on the inner circumference side of the back yoke portion, which is particularly a problem.

In view of the circumstances as described above, it is an object of the present invention to provide a technology for properly preventing an insulation member from melting during welding without reducing the efficiency of a motor.

### Solution to Problem

In order to achieve the above-mentioned object, a compressor according to an embodiment of the present invention includes a shaft; a motor; a compression unit; and a shell.

The motor includes a rotor fixed to the shaft and a stator surrounding the rotor.

The compression unit compresses a refrigerant as a result of rotation of the shaft.

The shell houses the shaft, the motor, and the compression unit therein.

The stator includes a stator core, coils, an insulation member, and at least one projection portion.

The stator core includes an annular back yoke portion that has an outer circumferential surface welded to the shell and an inner circumferential surface opposite to the outer circumferential surface, a plurality of teeth portions projecting from the inner circumferential surface, and slots formed between adjacent teeth portions,

The coils are wound around the plurality of teeth portions.

The insulation member is disposed in the slots and interposed between the stator core and the coils to insulate the stator core and the coils.

The at least one projection portion projects from the inner circumferential surface of the back yoke portion and forms a gap between the inner circumferential surface and the insulation member.

In this compressor, by the projection portions, the gap is formed between the inner circumferential surface of the back yoke portion and the insulation member. As a result, it is possible to prevent the inner circumferential surface of the back yoke portion and the insulation member from being in close contact with each other, and prevent the insulation member from melting during welding. Further, in this compressor, since the projection portions (instead of recesses) are formed on the inner circumferential surface of the back yoke portion, the magnetic path does not become narrow and long, which makes it possible to prevent the efficiency of the motor from being reduced.

In the above-mentioned compressor, the inner circumferential surface of the back yoke portion may have a corresponding area having a size corresponding to a size of a welding point of the shell and the outer circumferential surface of the stator core. In this case, the projection portion may be provided at a position outside the corresponding area.

By providing the projection portions at positions outside the corresponding area corresponding to the welding location as in this compressor, the heat during welding is less likely to be transmitted to the projection portions, which makes it possible to increase the effect of preventing the insulation member from melting.

In the above-mentioned compressor, the projection portion may include a first projection portion and a second projection portion disposed to sandwich the corresponding area in the circumferential direction.

In this compressor, by the two projection portions, it is possible to form the gap at an appropriate position with respect to the welding location.

In the above-mentioned compressor, the projection portion may include a first projection and a second projection portion disposed to sandwich the corresponding area in the axial direction.

In this compressor, by the two projection portions, it is possible to form the gap at an appropriate position with respect to the welding location.

In the above-mentioned compressor, the projection portion on a tip side in contact with the insulation member may be thin.

In this compressor, since the tip side of each of the projection portions is thin, it is possible to reduce the contact area with the insulation member to make it difficult for the heat during welding to be transmitted to the insulation member.

### Advantageous Effects of Invention

In accordance with the present invention, it is possible to properly prevent an insulation member from melting during welding without reducing the efficiency of a motor.

### BRIEF DESCRIPTION OF DRAWINGS

FIG. 1 is a partial cross-sectional view of a compressor viewed from a side.

FIG. 2 is a side view of a main shell viewed from an A direction shown in FIG. 1.

FIG. 3 is a diagram of a motor viewed from above, in which a top shell is removed from the main shell.

FIG. 4 is a cross-sectional view taken along the line B-B′ shown in FIG. 1, and is a diagram of a stator viewed from above.

FIG. 5 is a top view showing a stator core constituting a part of the motor.

FIG. 6 is a partially enlarged view of a stator according to a first embodiment viewed from above.

FIG. 7 is a diagram of a first projection portion and a second projection portion according to the first embodiment viewed from inside in the radial direction.

FIG. 8 is a partially enlarged view of a stator according to a second embodiment viewed from above.

FIG. 9 is a diagram of a first projection portion and a second projection portion according to the second embodiment viewed from inside in the radial direction.

### MODE(S) FOR CARRYING OUT THE INVENTION

Hereinafter, embodiments of the present invention will be described with reference to the drawings.

### First Embodiment

[Configuration of Entire Compressor 100 and Configuration of Respective Units]

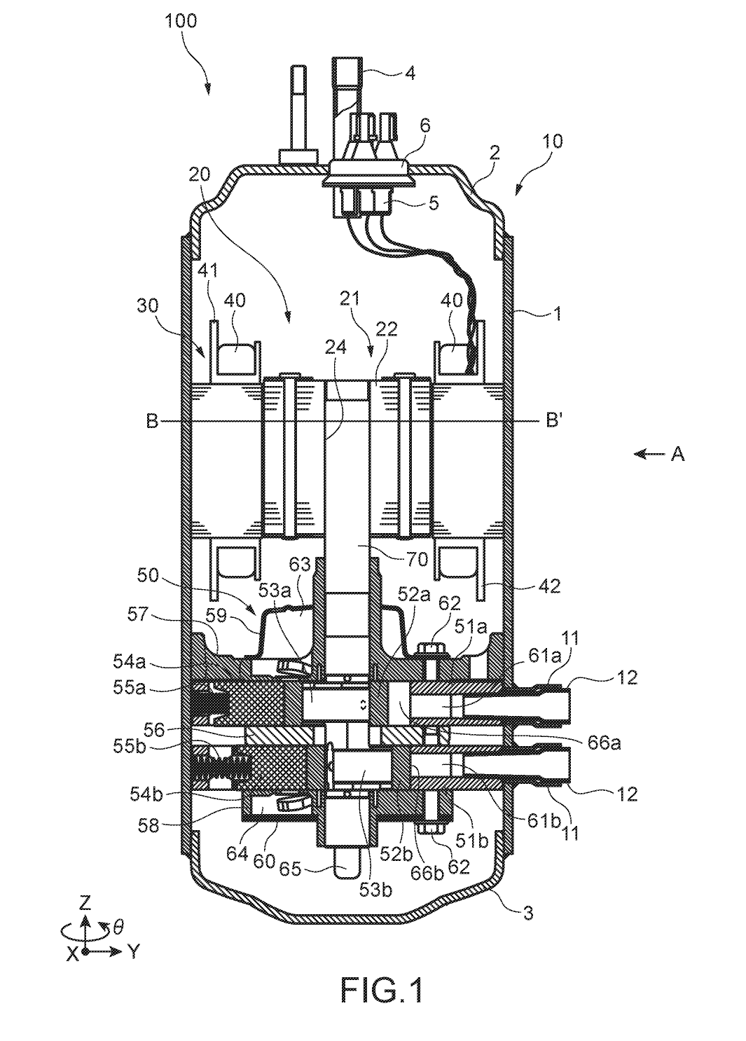

FIG. 1 is a partial cross-sectional view of a compressor viewed from a side. In FIG. 1, a part of a shell 10 and a part of a compression unit 50 are partially shown as a cross section.

As shown in FIG. 1, the compressor 100 includes a rotation axis 70 (a shaft), a motor 20, the compression unit 50 driven by the motor 20 via the rotation axis 70, and the shell 10 forming an enclosed space while housing the rotation axis 70, the motor 20, and the compression unit 50 therein. Note that although not shown, the compressor 100 includes an accumulator disposed on a side of the shell 10. This accumulator is disposed on the refrigerant inhalation side of the compressor 100. The accumulator houses a refrigerant (e.g., R32) therein, separates a gas refrigerant and a liquid refrigerant, and supplies the gas refrigerant to the compression unit 50.

[Shell 10]

The shell 10 includes a cylindrical main shell 1, which is long in the up-and-down direction (direction along the rotation axis 70 (Z axis direction): referred to also as axial direction in the specification) with the upper part and the lower part being opened. Further, the shell 10 includes a top shell 2 that seals the upper part of the main shell 1 and a bottom shell 3 that seals the lower part of the main shell 1.

To the top shell 2, a discharge pipe 4 for discharging a refrigerant compressed by the compression unit 50 to the outside of the shell 10 (e.g., an air conditioner or a refrigerator) is attached. Further, to the top shell 2, a terminal block 6 that holds a terminal 5 for supplying electric power to the motor 20 is attached.

In this embodiment, the motor 20 is disposed above the center inside the main shell 1, and the compression unit 50 is disposed below the center. Note that the positions of the motor 20 and the compression unit 50 inside the main shell 1 are not limited thereto, and can be appropriately changed.

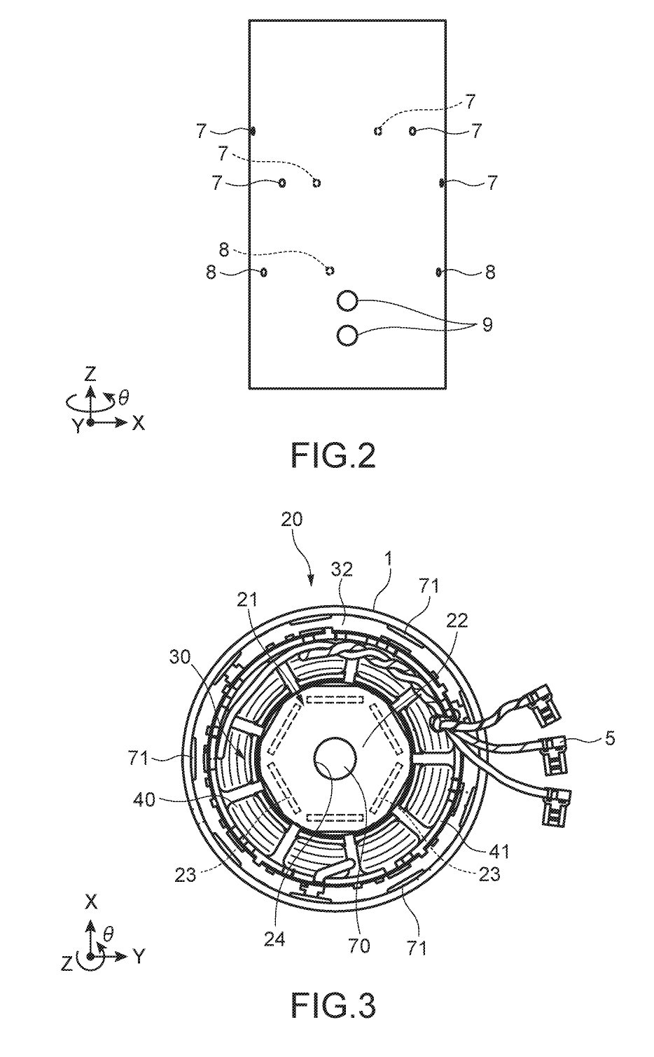

FIG. 2 is a side view of the main shell 1 viewed from an A direction shown in FIG. 1. As shown in FIG. 2, the compressor 100 has a plurality of welding points for fixing the motor 20 by welding (arc welding, laser welding, or the like) at positions (upper side) where the motor 20 is disposed. In this embodiment, as an example of the welding points, a plurality of welding holes 7 are provided in the main shell 1. The welding holes 7 penetrate the main shell 1 in the radial direction (direction orthogonal to the rotation axis 70), and each have a circular shape viewed from the radial direction in this embodiment.

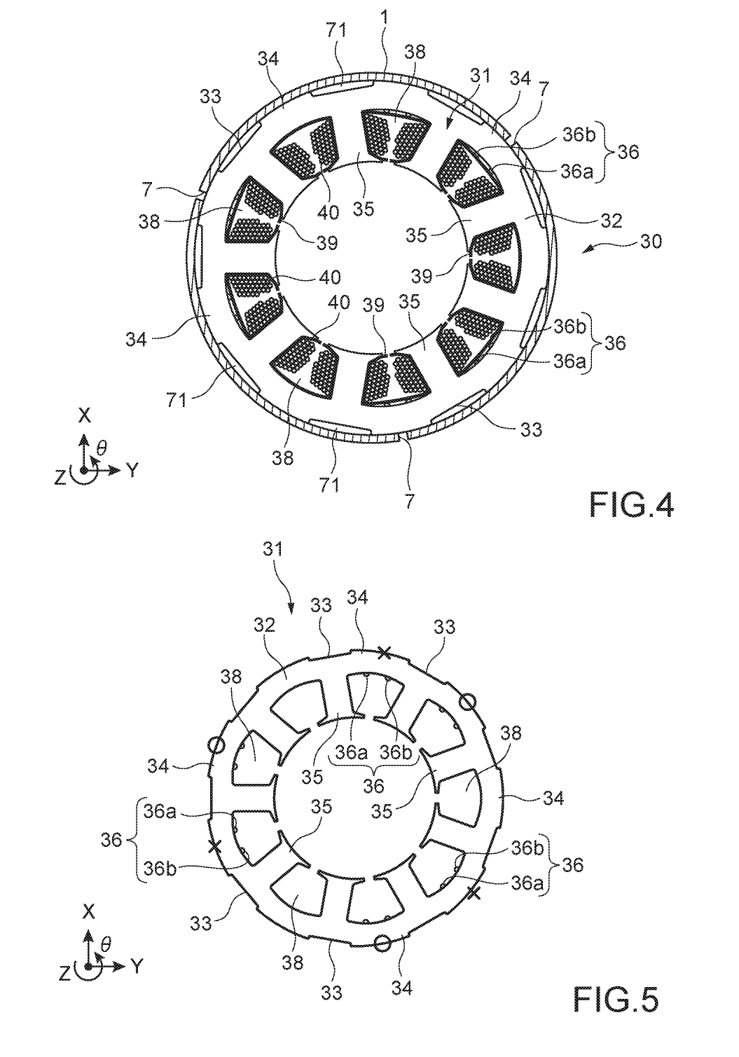

Three welding holes 7 are formed in each of two stages, i.e., the upper stage and the lower stage in the vertical direction, and the total number thereof is six. The three welding holes 7 located at the same stage are provided at intervals of 120° (i.e., equal intervals) in the circumferential direction (θ direction: rotation direction around the rotation axis 70) (see also FIG. 4 to be described later).

Note that the three welding holes 7 located in the upper stage and the three welding holes 7 located in the lower stage are formed at positions shifted by 40° in the circumferential direction. By disposing the welding holes 7 in two stages and shifting the positions thereof in the circumferential direction for each stage in this way, it is possible to firmly fix the motor 20 to the inside of the shell 10. Note that the number of stages in which the welding holes 7 are provided is not limited to two, and may be one, three, four, . . . . Further, the number of welding holes 7 located in the same stage is not limited to three, and may be one, two, four, . . . .

Similarly, the main shell 1 includes three welding holes 8 for fixing the compression unit 50 by welding at positions (lower side) where the compression unit 50 is disposed. The welding holes 8 are provided at intervals of 120° at the same height positions.

Further, the main shell 1 includes two openings 9 disposed so as to be lined up in the vertical direction at positions (lower side) where the compression unit 50 is disposed. Joint pipes 11 are inserted into the openings 9. To the joint pipes 11, inhalation pipes 12 for supplying, to the compression unit 50, a refrigerant from the accumulator are connected (see FIG. 1).

[Compression Unit 50]

Referring to FIG. 1, the compression unit 50 includes cylinders 51a and 51b disposed so as to be lined up in the vertical direction, annular pistons 52a and 52b disposed inside the cylinders 51a and 51b, and eccentric cranks 53a and 53b disposed inside the annularpistons 52a and 52b. Further, the compression unit 50 includes vanes 54a and 54b that come into contact with the annularpistons 52a and 52b, and spring members 55a and 55b that urge the vanes 54a and 54b toward the side of the annular pistons 52 (inside in the radial direction).

Further, the compression unit 50 includes a partition plate 56 interposed between the two cylinders 51, an upper plate member 57 disposed on the upper part of the upper-side cylinder 51a, and a lower plate member 58 disposed on the lower side of the lower-side cylinder 51b. Further, the compression unit 50 includes an upper muffler cover 59 disposed on the upper side of the upper plate member 57 and a lower muffler cover 60 disposed on the lower side of the lower plate member 58.

The eccentric cranks 53a and 53b are fixed to the lower end of the rotation axis 70 fixed to a rotor core 22 of the motor 20 (which will be described in detail later), and rotatable in accordance with the rotation of the rotor core 22. Note that the upper-side eccentric crank 53a and the lower-side eccentric crank 53b are fixed to the rotation axis 70 in a state where the phase of the eccentricity is shifted by 180°.

The cylinders 51a and 51b each have an inner circumferential surface concentric with the rotation axis 70, and the annularpistons 52a and 52b are each disposed in spaces surrounded by the corresponding inner circumferential surfaces. The spaces sandwiched between the inner circumferential surfaces of the cylinders 51a and 51b and the outer circumferential surface of the annularpistons 52a and 52b respectively form cylinder chambers 66a and 66b. Inhalation ports 61a and 61b fitted to the inhalation pipes 12 are provided in the cylinders 51a and 51b. A refrigerant is inhaled via the inhalation ports 61a and 61b. Further, vane grooves that radially extend outward from the centers of the cylinder chambers 66a and 66b are provided in the cylinders 51a and 51b. The vanes 54a and 54b are slidable in the radial direction along the vane grooves.

The annularpistons 52a and 52b are rotatably fitted to the eccentric cranks 53a and 53b. The annularpistons 52a and 52b are capable of eccentrically move in accordance with the rotation of the eccentric cranks 53a and 53b while a part of each of the outer circumferential surfaces is in contact with the inner circumferential surface of the corresponding cylinders 51a and 51b.

The vanes 54a and 54b are each a plate-shaped member that is thin in the circumferential direction, and are respectively urged toward the side of the annularpistons 52a and 52b by the urging force of the spring members 55a and 55b, respectively. Since the vanes 54a and 54b are respectively urged toward the side of the annularpistons 52a and 52b, the tips (inside in the radial direction) thereof always come into contact with the outer circumferential surfaces of the annularpistons 52a and 52b even in the case where the annularpistons 52a and 52b eccentrically move. That is, the vanes 54a and 54b are capable of reciprocating, when the annularpistons 52a and 52b eccentrically move, in the vane grooves following the eccentric movement.

The cylinder chambers 66a and 66b are partitioned by the vanes 54a and 54b, and the cylinder chambers 66a and 66b are separated into two chambers, i.e., an inhalation chamber and a compression chamber. When the annularpistons 52a and 52b respectively eccentrically move in the cylinders 51a and 51b, the volume of the two chambers change in a continuous manner (when the volume of one chamber is increases, the volume of the other chamber decreases). This movement allows the compression unit 50 to inhale or compress a refrigerant.

The upper plate member 57 is a member that blocks the upper-side cylinder 51a with the partition plate 56. The upper plate member 57 rotatably pivotally supports the rotation axis 70 of the motor 20 at the center thereof. Further, the outer circumferential surface of the upper plate member 57 is welded to the main shell 1 via the above-mentioned three welding holes 8. Note that the respective members (the upper muffler cover 59, the upper plate member 57, the upper-side cylinder 51a, the partition plate 56, the lower-side cylinder 51b, the lower plate member 58, and the lower muffler cover 60) constituting the compression unit 50 are integrally connected to each other via a bolt 62. Therefore, by fixing the outer circumferential surface of the upper plate member 57 to the main shell 1, the compression unit 50 is integrally fixed to the inside of the shell 10.

The upper muffler cover 59 is a member for forming an upper muffler chamber 63 between the upper muffler cover 59 and the upper plate member 57. In this upper muffler chamber 63, the refrigerant compressed by the upper-side compression chamber is introduced.

The lower plate member 58 is a member that blocks the lower-side cylinder 51 with the partition plate 56. The lower plate member 58 rotatably pivotally supports the rotation axis 70 of the motor 20 at the center thereof.

The lower muffler cover 60 is a member for forming a lower muffler chamber 64 between the lower muffler cover 60 and the lower plate member 58. In the lower muffler chamber 64, the refrigerant compressed by the lower-side compression chamber is introduced. Note that the refrigerant introduced in the lower muffler chamber 64 is introduced into the upper muffler chamber 63 via a refrigerant path (not shown) penetrating the lower plate member 58, the lower-side cylinder 51b, the partition plate 56, the upper-side cylinder 51a, and the upper plate member 57. The refrigerant introduced in the upper muffler chamber 63 is released to the space inside the shell 10.

Note that lubricating oil is enclosed in the main shell 1 up to the height of the upper-side cylinder 51a. This lubricating oil is sucked up from an oil supply pipe 65 attached to the lower end of the rotation axis 70 by a vane pump (not shown) inserted in the lower part of the rotation axis 70, and circulates in the compression unit 50. As a result, the lubricating oil seals a minute gap of the compression unit 50 while lubricating the movement of the respective units in the compression unit 50.

[Motor 20]

FIG. 3 is a diagram of the motor 20 viewed from above, in which the top shell 2 is removed from the main shell 1. FIG. 4 is a cross-sectional view taken along the line B-B′ shown in FIG. 1, and is a diagram of a stator 30 viewed from above. FIG. 5 is a top view showing a stator core 31 constituting a part of the motor 20.

Referring to FIGS. 1 and 3 to 5, the motor 20 according to this embodiment is, for example, the radial gap motor 20, and includes a rotatable rotor 21 and a stator 30 surrounding the rotor 21. The rotor 21 includes the rotor core 22 and a plurality of permanent magnets 23. Further, the stator 30 includes the stator core 31, a plurality of coils 40, a plurality of insulation films 39, an upper-side insulation end plate 41, and a lower-side insulation end plate 42.

The rotor core 22 includes thin plates that are each thin in the axial direction and formed of a metal material, which are laminated in the axial direction. The rotor core 22 is a cylindrical member in which a through hole 24 is provided along the axial direction at the center thereof. The upper part of the rotation axis 70 is inserted in the through hole 24 of the rotor core 22, and fixed thereto. The plurality of permanent magnetics 23 are disposed inside the rotor core 22 at equal intervals along the circumferential direction.

The stator core 31 includes thin plates that are each thin in the axial direction and formed of a metal material, which are laminated in the axial direction, similarly to the rotor core 22. The stator core 31 includes an annular back yoke portion 32, and a plurality of teeth portions 35 that project from the inner circumferential surface of the back yoke portion 32 toward the inside in the radial direction. At the position inside the plurality of teeth portions 35 in the radial direction (i.e., the center of the stator core 31), the rotor 21 is disposed via a gap in the radial direction.

The plurality of teeth portions 35 are disposed at equal intervals (40°) along the circumferential direction. In this embodiment, the number of teeth portions 35 is nine. The coils 40 are respectively wound around the plurality of teeth portions 35.

The back yoke portion 32 is an annular member formed concentrically with the rotation axis 70, and has an outer circumferential surface and an inner circumferential surface. In the outer circumferential surface of the back yoke portion 32, cut portions 33 obtained by cutting the outer circumferential surface along the axial direction are formed. The cut portions 33 are formed at positions (positions on the outside in the radial direction) corresponding to the positions where the teeth portions 35 are provided. In this embodiment, nine cut portions 33 are formed in the circumferential direction at equal intervals (40°). Between the cut portions 33 and the main shell 1, gaps 71 are formed. The gaps 71 penetrate the motor 20 in the axial direction. The gaps 71 are used as a path for returning, to the lower side in the main shell, the lubricating oil discharged together with the refrigerant upward in the main shell 1 from the compression unit 50.

Note that parts of the outer circumferential surface of the back yoke portion 32 in which the cut portions 33 is not formed, which are in contact with the main shell 1, will be referred to as contact portions 34. In this embodiment, nine contact portions 34 are formed in the circumferential direction at equal intervals (40°).

The positions of the above-mentioned six welding holes 7 of the main shell 1 are set considering the positions of the contact portions 34. That is, the three welding holes 7 in the upper stage disposed at intervals of 120° among the six welding holes 7 in the main shell 1 are disposed at the positions (positions on the outside in the radial direction) corresponding to the three contact portions 34 located at intervals of 120°. Welding is performed in the three contact portions 34 (see circle marks in FIG. 5). Similarly, the three welding holes 7 in the lower stage disposed at intervals of 120° among the six welding holes 7 are disposed at the positions (positions on the outside in the radial direction) corresponding to the three contact portions 34 located at intervals of 120°. Welding is performed in the three contact portions 34 (see cross marks in FIG. 5).

As described above, the three welding holes 7 in the upper stage and the three the welding holes 7 in the lower stage are each formed to be shifted by 40° in the circumferential direction. Therefore, the angles between the three contact portions 34 (see circle marks) welded to the three welding holes 7 in the upper stage and the three contact portions 34 (see cross marks) welded to the three welding holes 7 in the lower stage are shifted by 40°. Note that in FIG. 4, the three welding holes 7 in the upper stage among the six welding holes 7 are shown.

Between each adjacent two teeth portions 35 among the plurality of teeth portions 35, a slot 38 is formed (nine slots in this embodiment). The insulation films 39 each formed of a resin material are disposed in the slots 38.

The insulation films 39, the upper-side insulation end plate 41, and the lower-side insulation end plate 42 are each an insulation member for insulating the stator core 31 (the teeth portions 35 and the back yoke portion 32) and the coils 40. The insulation films 39 are provided inside the slots 38 so as to cover a pair of side surfaces facing each other in the adjacent two teeth portions 35 and the inner circumferential surface of the back yoke portion 32. Further, the insulation films 39 are interposed between the pair of side surfaces facing each other in the adjacent two teeth portions 35 and the coils 40, and between the inner circumferential surface of the back yoke portion 32 and the coils 40.

The upper-side insulation end plate 41 is an annular member that covers the upper surface of the teeth portions 35 and is short in the axial direction. The upper-side insulation end plate 41 is interposed between the upper surface of the teeth portions 35 and the coils 40 to insulate the teeth portions 35 and the coils 40. Similarly, the lower-side insulation end plate 42 is an annular member that covers the lower surface of the teeth portions 35 and is short in the axial direction. The lower-side insulation end plate 42 is interposed between the lower surface of the teeth portions 35 and the coils 40 to insulate the teeth portions 35 and the coils 40.

Note that in this embodiment, the insulation member includes the insulation films 39 and the insulation end plates 41 and 42. However, the present invention is not limited thereto. That is, the insulation member only needs to have a structure capable of insulating the stator core 31 and the coils 40. For example, the insulation member may include only the insulation films 39, or the insulation films 39, the insulation end plate 41, and/or the insulation end plate 42 may be integrally formed.

(First Projection Portions 36a and Second Projection Portions 36b)

Next, first projection portions 36a and second projection portions 36b will be described. As described above, in this embodiment, the six welding holes 7 are provided for fixing the motor 20 to the main shell 1. Correspondingly, in this embodiment, the first projection portions 36a and the second projection portions 36b are provided at positions in the six slots 38 corresponding to the welding holes 7 (see FIG. 4 and FIG. 5). Since the first projection portions 36a and the second projection portions 36b have similar configurations at each position, the first projection portion 36a and the second projection portion 36b provided at one position among them will be representatively described.

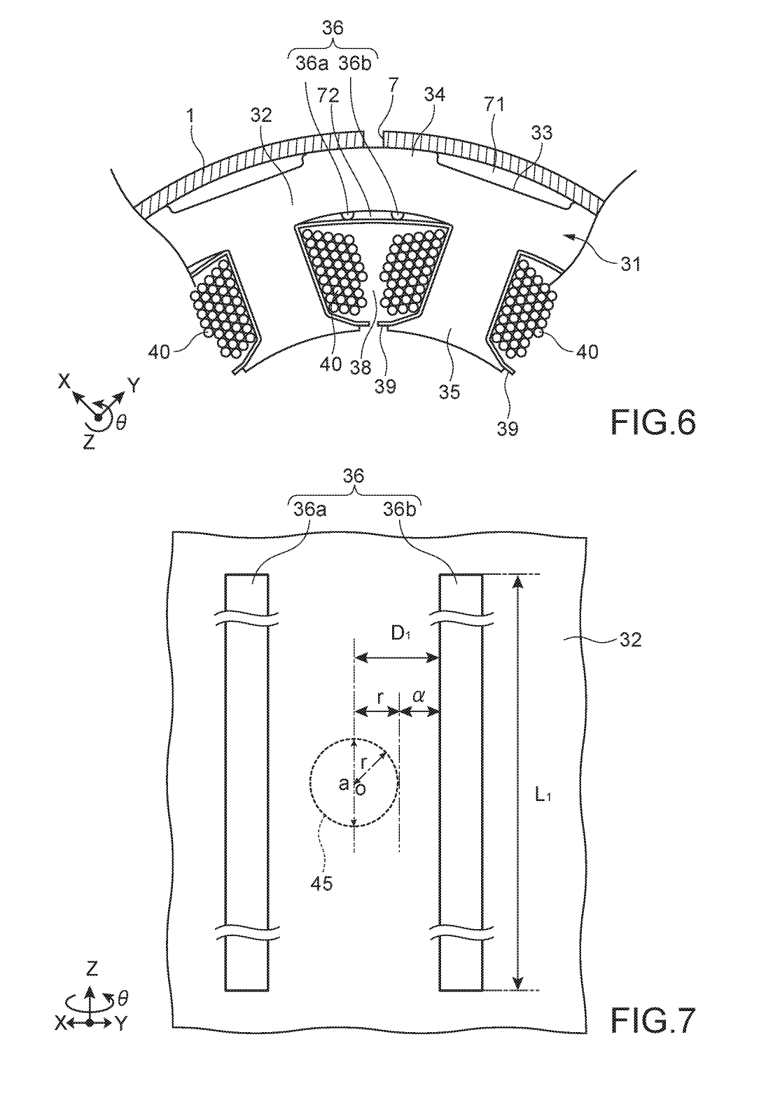

FIG. 6 is a cross-sectional view taken along the line B-B′ shown in FIG. 1, and is a partially enlarged view of the stator 30 viewed from above. FIG. 7 is a diagram of the first projection portions 36a and the second projection portions 36b viewed from inside in the radial direction. As shown in FIG. 6 and FIG. 7, the first projection portion 36a and the second projection portion 36b project from the inner circumferential surface (part facing the slot 38) of the back yoke portion 32 toward the inside in the radial direction. The first projection portion 36a and the second projection portion 36b cause the part covering the inner circumferential surface of the back yoke portion 32 in the insulation film 39 to project toward the inside in the radial direction to form a gap 72 between the inner circumferential surface of the back yoke portion 32 and the insulation film 39.

The first projection portion 36a and the second projection portion 36b are formed to be long in the axial direction. Further, the first projection portion 36a and the second projection portion 36b on the tip side in contact with the insulation film 39 are thin. Specifically, the first projection portion 36a and the second projection portion 36b are each formed to have a round shape on the tip side in contact with the insulation film 39. In this embodiment, as shown in FIG. 6, they are each formed to have a semicircular shape viewed from above.

Since the first projection portion 36a and the second projection portion 36b are each formed to be long in the axial direction and to be thin and have a round shape on the tip side, they are each in contact with the insulation film 39 in a long linear shape (having some width) in the axial direction.

Here, in the present specification, the area located inside the welding holes 7 in the radial direction and on the inner circumferential surface of the back yoke portion 32 is referred to as a corresponding area 45 (see broken line in FIG. 7). The corresponding area 45 is an area having a size corresponding to the size of the welding hole 7. That is, the corresponding area 45 is an area on the inner circumferential surface of the back yoke portion 32 when projecting the welding hole 7 toward the inside in the radial direction.

The first projection portion 36a and the second projection portion 36b are formed symmetrically in the circumferential direction with the corresponding area 45 sandwiched therebetween, and provided at positions outside the corresponding area 45. Specifically, the first projection portion 36a is disposed at a position outside the corresponding area 45 in the circumferential direction, and the second projection portion 36b is disposed on the opposite side from the first projection portions 36a with the corresponding area 45 sandwiched therebetween in the circumferential direction.

A distance D₁ from a center O of the corresponding area 45 in the circumferential direction to the end portion of the first projection portion 36a or the second projection portion 36b on the side of the corresponding area 45 has a value (D₁=r+α) obtained by adding a predetermined distance α to a radius r of the corresponding area 45 (radius r of the welding hole 7). That is, a margin area where the first projection portion 36a and the second projection portion 36b are not provided is set around the corresponding area 45. The distance α has a value determining the size of this margin area.

Here, in the case where the predetermined distance α is too small, there is a possibility that heat is transmitted to the insulation film 39 via the first projection portion 36a and the second projection portion 36b. Meanwhile, in the case where the predetermined distance α is too large, there is a possibility that the insulation film 39 is not properly separated from the inner circumferential surface of the back yoke portion 32. Further, in the case where the predetermined distance α is too large, there is a possibility that the first projection portion 36a and the second projection portion 36b come too close to the teeth portions 35. In this case, the first projection portion 36a and the second projection portion 36b are disposed at positions where the density of the coils 40 is high, and there is a possibility that the first projection portion 36a and the second projection portion 36b become an obstacle to wind the coils 40 around the teeth portions 35.

Taking these facts into consideration, the predetermined distance α is set. For example, the predetermined distance α is approximately 0.2 to 1.5 times the radius r of the corresponding area 45 (D₁=1.2r to 2.5r).

The length of each of the first projection portion 36a and the second projection portion 36b in the circumferential direction is set to L₁. In the case where the length L₁ is too small, the length of the gap 72 in the axial direction is short, and it is difficult to properly separate the insulation film 39 from the back yoke portion 32. Meanwhile, there is no problem if the length L₁ is too large. However, there is no need to form the gap 72 unnecessarily to the portion where heat during welding is difficult to be transmitted.

Taking these facts into consideration, the length L₁ of each of the first projection portion 36a and the second projection portion 36b in the axial direction is set. For example, this length L₁ is approximately 8 to 16 times a diameter a of the welding hole 7 (8a≤L₁≤16a).

Further, in the case where the height of projection of each of the first projection portion 36a and the second projection portion 36b in the radial direction is too small, the insulation film 39 is not properly separated from the inner circumferential surface of the back yoke portion 32. In the case where the height is too large, they become an obstacle of the coils 40. Therefore, the height of projection of each of the first projection portion 36a and the second projection portion 36b in the radial direction is appropriately set taking these facts into consideration. For example, this height is set to approximately 2 mm to 5 mm.

Note that the first projection portion 36a and the second projection portion 36b are integrally formed with the stator core 31. Here, as described above, the stator core 31 includes a plurality of thin plates that are each thin in the axial direction and formed of a metal material, which are laminated in the axial direction. In the case of producing the stator core 31, two types of thin plates, i.e., a first thin plate in which the first projection portion 36a and the second projection portion 36b are formed, and a second thin plate in which the first projection portion 36a and the second projection portion 36b are not formed are prepared. Then, the first thin plate is laminated on the part where the first projection portion 36a and the second projection portion 36b need to be formed in the axial direction, and the second thin plate is laminated on the other parts.

[Operations, Etc.]

In this embodiment, the first projection portion 36a and the second projection portion 36b cause the insulation film 39 to project toward the inside in the radial direction to form the gap 72 between the inner circumferential surface of the back yoke portion 32 and the insulation film 39. With the gap 72, it is possible to prevent the inner circumferential surface of the back yoke portion 32 and the insulation films 39 from being in close contact with each other, which makes it possible to prevent the insulation film 39 from melting by the heat during welding. Further, in this embodiment, since instead of a recess, the projection portion 36 is formed on the inner circumferential surface of the back yoke portion 32, it is possible to prevent the efficiency of the motor 20 from being reduced by the narrowed and lengthened magnetic path and the increased magnetic resistance.

Further, in this embodiment, the first projection portion 36a and the second projection portion 36b are provided at positions outside the corresponding area 45 corresponding to the welding hole 7 on the inner circumferential surface of the back yoke portion 32. Therefore, it is difficult for the heat during welding to be transmitted to the first projection portion 36a and the second projection portion 36b, which makes it possible to further appropriately prevent the insulation film 39 from melting.

Further, in this embodiment, the margin area (the distance α) where the first projection portion 36a and the second projection portion 36b are not provided is set around the corresponding area 45 on the inner circumferential surface of the back yoke portion 32. As a result, it is further difficult for the heat during welding to be transmitted to the first projection portion 36a and the second projection portion 36b, which makes it possible to further appropriately prevent the insulation film 39 from melting.

Further, in this embodiment, the first projection portion 36a is disposed at a position outside the corresponding area 45 in the circumferential direction, and the second projection portion 36b is disposed on the side opposite to the first projection portions 36a with the corresponding area 45 sandwiched therebetween in the circumferential direction. As a result, it is possible to form the gap 72 at an appropriate position with respect to the welding holes 7, which makes it possible to further appropriately prevent the insulation film 39 from melting.

Further, in this embodiment, since the tip of each of the first projection portion 36a and the second projection portion 36b is thin, it is possible to reduce the contact area with the insulation film 39. As a result, it is possible to further reduce the influence of the heat on the insulation film 39. Further, since the tip of each of the first projection portion 36a and the second projection portion 36b has a round shape, it is possible to prevent the insulation member from being damaged due to the projection portions.

Further, since the length (in the axial direction) of each of the first projection portion 36a and the second projection portion 36b is appropriately set, it is possible to further appropriately prevent the insulation film 39 from melting. Further, by appropriately setting the height (in the radial direction) of each of the first projection portion 36a and the second projection portion 36b, it is possible to prevent the insulation film 39 from being an obstacle of the coils 40 while appropriately separating the insulation film 39 from the inner circumferential surface of the back yoke portion 32. Note that even in the case where the height (in the radial direction) of each of the first projection portion 36a and the second projection portion 36b is low, it has a sufficient effect.

### Second Embodiment

Next, a second embodiment of the present invention will be described. In the description of the second embodiment and subsequent examples, members having similar configurations and functions to those of the first embodiment will be denoted by the same reference symbols and description thereof will be simplified or omitted.

In the second embodiment, the configurations of first projection portions 36c and second projection portions 36d are different from those in the above-mentioned first embodiment. Thus, this point will be mainly described.

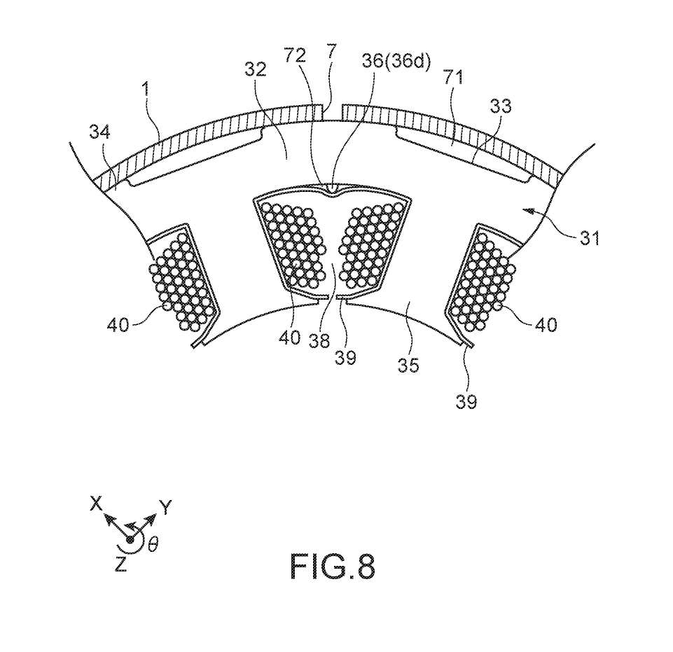

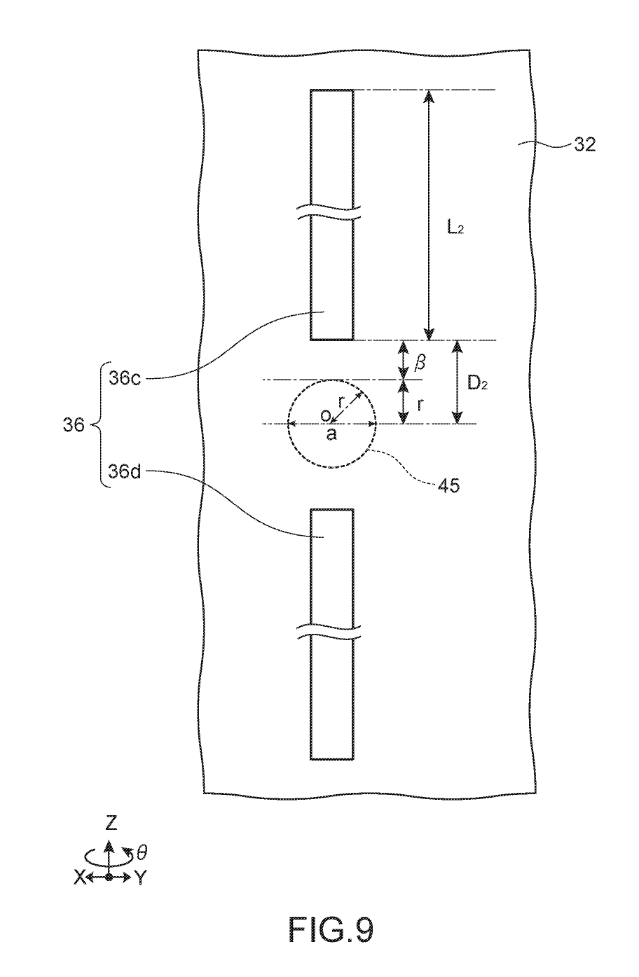

FIG. 8 is a partially enlarged view of the stator 30 according to the second embodiment viewed from above. FIG. 9 is a diagram of the first projection portion 36c and the second projection portion 36d according to the second embodiment viewed from inside in the radial direction.

As shown in these figures, the first projection portion 36c and the second projection portion 36d according to the second embodiment each have a shape long in the axial direction similarly to the first embodiment, and each have a semicircular shape viewed from above as shown in FIG. 8.

Here, although they are formed symmetrically in the circumferential direction with the corresponding area 45 sandwiched therebetween in the above-mentioned first embodiment, the first projection portion 36c and the second projection portion 36d according to the second embodiment are formed symmetrically in the axial direction with the corresponding area 45 sandwiched therebetween. Note that also in the second embodiment, the first projection portion 36c and the second projection portion 36d are provided at positions outside the corresponding area 45 similarly to the first embodiment.

Specifically, the first projection portion 36c is disposed at a position outside the corresponding area 45 in the axial direction, and the second projection portion 36d is disposed on the opposite side of the first projection portion 36c with the corresponding area 45 sandwiched therebetween in the axial direction. Note that the first projection portion 36c and the second projection portion 36d are formed as if one projection portion 36 extending in the axial direction is cut out in the vicinity of the corresponding area 45, and linearly disposed in the axial direction.

In the axial direction, a distance D₂ from the center O of the corresponding area 45 to the end portion of the first projection portion 36c or the second projection portion 36d on the side of the corresponding area 45 has a value (D₂=r+β) obtained by adding a predetermined distance β to the radius r of the corresponding area 45 (radius r of the welding hole 7). That is, a margin area where the first projection portion 36c and the second projection portion 36d are not provided is set around the corresponding area 45. The distance β has a value determining the size of this margin area.

The idea on the distance β is basically the same as that on the above-mentioned distance α. However, although there has been a possibility that the first projection portion 36a and the second projection portion 36b come too close to the teeth portions 35, and become an obstacle of the coils 40 in the case where the distance α is too large, the first projection portion 36c and the second projection portion 36d do not come close to the teeth portions 35 even in the case where the distance β is increased. Therefore, this point is not considered.

For example, the predetermined distance β is approximately 0.2 to 1.5 times the radius r of the corresponding area 45 similarly to the predetermined distance α (D₂=1.2r to 2.5r).

Here, since the stator core 31 includes thin plates that are each thin in the axial direction, which are laminated in the axial direction, it is considered that the heat during welding is less likely to be transmitted in the axial direction than in the circumferential direction. Therefore, the predetermined distance β may be smaller than the predetermined distance α. In this case, for example, the predetermined distance β is approximately 0.1 to 1 times the radius r of the corresponding area 45 (D₂=1.1r to 2.0r).

Note that although the margin area around the corresponding area has a circular shape in the case where the distance β is the same as the distance α, the margin area has an elliptical shape short in the axial direction in the case where the distance β is smaller than the distance α.

The idea on a length L₂ (in the axial direction) of each of the first projection portion 36c and the second projection portion 36d is basically similar to that in the first embodiment. Note that regarding the length L₂ of each of the first projection portion 36c and the second projection portion 36d according to the second embodiment, for example, the value obtained by adding the interval (2×D₂) between the two projection portions to the total length of the two projection portions 36 is substantially equal to the length L₁ of each of the first projection portions 36a and the second projection portions 36b according to the first embodiment. In this case, this length L₂ is approximately three to 7 times the diameter a of the welding hole 7 (3a≤L₂≤7a).

The idea on the height (in the radial direction) of the first projection portion 36c and the second projection portion 36d is also basically the same as that in the first embodiment. However, the first projection portion 36c and the second projection portion 36d according to the second embodiment are each provided at a position intermediate between the adjacent two coils 40, i.e., a position where the density of the coils 40 is sparse. Therefore, in the second embodiment, for example, it is possible to make the height of each of the projection portions 36c and 36d higher than those in the first embodiment. As a result, it is possible to further appropriately prevent the insulation films 39 from melting. For example, the height of each of the first projection portion 36c and the second projection portion 36d according to the second embodiment is approximately 2 mm to 10 mm.

Here, the projection portion 36 is formed as if a part thereof is cut out in the corresponding area 45 (or the corresponding area+the distance β) in the axial direction.

Also in this second embodiment, the operation and effect similar to those in the above-mentioned first embodiment are exerted. Note that in the second embodiment, there is a merit that the first projection portion 36c and the second projection portion 36d are less likely to become an obstacle of the coils 40.

### Various Modified Examples

In the above description, the case where the number of projection portions 36 is two has been described. Meanwhile, the number of projection portions 36 may be one. For example, the second projection portions 36b according to the first embodiment may be omitted. In this case, by increasing the height of each of the first projection portions 36a according to the first embodiment, it is possible to appropriately form the gaps 72 between the inner circumferential surface of the back yoke portion 32 and the insulation films 39.

Further, the number of projection portions 36 may be three or more. For example, in the first embodiment, two projection portions on the right side of the corresponding area 45 and two projection portions on the left side of the corresponding area 45, i.e., total four projection portions may be provided. Alternatively, in the second embodiment, two projection portions on the upper side of the corresponding area 45 and two projection portions on the lower side of the corresponding area 45, i.e., total four projection portions may be provided. Alternatively, the two projection portions 36 in the first embodiment and the two projection portions 36 in the second embodiment, i.e., total four projection portions 36 may be provided.

In the above description, the case where the projection portions 36 on the tip side are each formed to have a round shape has been described. However, it does not necessarily need to form the tip of each of the projection portions 36 to have a round shape. For example, the projection portions 36 may each have a rectangular shape viewed from above as shown in FIG. 6 and FIG. 8.

In the above description, the case where the projection portions 36 each have a shape long in the axial direction has been described. Meanwhile, the projection portions 36 may each have a shape long in the circumferential direction. Alternatively, the projection portions 36 may each be formed to have an annular shape so as to surround the corresponding area 45 viewed from the radial direction. Alternatively, the projection portions 36 may each be shaped to be scattered.

Typically, each of the projection portions 36 only needs to have a shape capable of appropriately forming the gap 72 between the inner circumferential surface of the back yoke portion 32 and the insulation film 39 at least in the vicinity of the corresponding area 45.

In the above description, the case where the predetermined distances α and β, the lengths L₁ and L₂, and the height of the projection portion 36 are set within a predetermined range has been described. Meanwhile, it is considered that the influence of the heat during welding on the insulation films 39 is reduced as it is farther away from the center O of the corresponding area 45. Therefore, the projection portions 36 may be provided in the area of the corresponding area 45, and at least the insulation films 39 only need to be not in contact at the center O of the corresponding area 45.

In the above description, the case where the welding holes 7 each have a circular shape has been described. However, the shape of each of the welding holes 7 may be a regular polygon, a star, or the like, and the shape is not particularly limited. In the above description, as an example of welding points, the welding holes 7 have been described. Meanwhile, holes do not necessarily need to be provided at welding points (for example, in the case of laser welding). Further, the shape of each of the welding points does not necessarily need to be a circular shape, a regular polygonal shape, or the like, and may be a shape long in one direction (for example, in the case of laser welding).

### REFERENCE SIGNS LIST

7 welding hole
10 shell
20 motor
21 rotor
30 stator
31 stator core
32 back yoke portion
35 teeth portion
36a, 36b, 36c, 36d, 36 projection portion
38 slot
39 insulation film
40 coils
45 corresponding area
70 rotation axis
100 compressor

1. A compressor, comprising:
a shaft;
a motor including a rotor fixed to the shaft and a stator surrounding the rotor;
a compression unit that compresses a refrigerant as a result of rotation of the shaft;
a shell that houses the shaft, the motor, and the compression unit therein, wherein the stator includes
a stator core including an annular back yoke portion that has an outer circumferential surface welded to the shell and an inner circumferential surface opposite to the outer circumferential surface, a plurality of teeth portions projecting from the inner circumferential surface, and slots formed between adjacent teeth portions,
coils wound around the plurality of teeth portions,
an insulation member that is disposed in the slots and interposed between the stator core and the coils to insulate the stator core and the coils, and
at least one projection portion that projects from the inner circumferential surface of the back yoke portion and forms a gap between the inner circumferential surface and the insulation member.

2. The compressor according to claim 1, wherein
the inner circumferential surface of the back yoke portion has a corresponding area having a size corresponding to a size of a welding point of the shell and the outer circumferential surface of the stator core, and
the projection portion is provided at a position outside the corresponding area.

3. The compressor according to claim 2, wherein
the projection portion includes a first projection portion and a second projection portion disposed to sandwich the corresponding area in the circumferential direction.

4. The compressor according to claim 2, wherein
the projection portion includes a first projection and a second projection portion disposed to sandwich the corresponding area in the axial direction.

5. The compressor according to claim 1, wherein
the projection portion on a tip side in contact with the insulation member is thin.

6. The compressor according to claim 2, wherein
the projection portion on a tip side in contact with the insulation member is thin.

7. The compressor according to claim 3, wherein
the projection portion on a tip side in contact with the insulation member is thin.

8. The compressor according to claim 4, wherein
the projection portion on a tip side in contact with the insulation member is thin.
